(19) United States
(12) Patent Application Publication
(10) Pub. No.: US 2024/0202639 A1
(43) Pub. Date: Jun. 20, 2024

(54) A Method and System for Prioritizing Business Opportunities

(71) Applicant: Roy Rajan, Wilmington, DE (US)

(72) Inventor: Roy Rajan, Wilmington, DE (US)

(21) Appl. No.: 18/536,291

(22) Filed: Dec. 12, 2023

Related U.S. Application Data
(60) Provisional application No. 63/432,391, filed on Dec. 14, 2022.

(51) Int. Cl. G06Q 10/0639

(52) U.S. Cl. CPC G06Q 10/06393; G06Q 10/06398

(57) ABSTRACT

The present disclosure relates to a method for prioritizing business opportunities. The method includes periodically analyzing activities performed by a group of buying committee members, determining a score for each of the group of buying committee members based on the analysis. The method comprises computing a persona score based on the determined scores of the buying committee members, determining a base opportunity score based on weighted average of the computed persona score. The method further comprises determining a surge score by analyzing intent signals from accounts, and determining an opportunity score based on the base opportunity score and the surge score.

### CROSS REFERENCE

This non-provisional patent application claims benefit of U.S. Provisional Patent Application Ser. No. 63/432,391, filed Dec. 14, 2022, and hereby claims the benefit of the embodiments therein and of the filing date thereof.

### FIELD OF THE INVENTION

The present invention is related, generally to prioritizing Business Opportunities and more particularly, but not exclusively to a method and system for scoring and prioritizing business opportunities among a plurality of such Opportunities based on the interactions with Buying Committee Members associated with the Opportunity and first and third-Party Intent signals associated with each Account.

### BACKGROUND

Opportunities are deals in progress. Opportunity records track details about deals, including which accounts they're for, who the Buying Committee Members are, and the amount of potential sales and by when it is expected to close.

An Account is a business entity, usually a company. Accounts are therefore companies that an organization is doing business with or has potential of doing business with. An Account is an organization that is a qualified potential customer, an existing customer, partner, competitor or has a relationship of similar significance. Accounts should be created for organizations (companies, nonprofits, foundations), and individuals.

To interact with an account, the organization typically interacts with a plurality of Buying Committee Members. A Buying Committee Member is a decision maker or influencer at the Account who has been tasked to find a solution to a business need/problem that exists within the Account. Further, demand generation is the process of attracting and converting strangers and prospects into Opportunities that have indicated interest in products or services of an organization. Demand generation is an increasingly popular strategy, which provides better reach through multichannel broadcasting of the generated message coordinated across multiple Leads. Demand generation assists organizations in achieving a greater brand awareness, building relationships and attracting more potential clients to fill their sales pipeline.

Demand generation strategy also describes the marketing process of involvement and capture of interest in a product or service which is aimed at developing sales plans and, as a consequence, soliciting new clients.

There is a plurality of systems that typically prioritize Buying Committee Members, where such are indicate worthiness of accounts, by attributing values to such worthiness based on the behavior of the Buying Committee Members relating to interest in products or services. Such systems do not consider the influence of related Buying Committee Members together within a particular organization. In an example scenario, an organization providing service and/or product identifies an account for selling service and/or product of the provider organization. The existing systems would determine relevant buying committee members in the organization and assign a score to each member based on their responses. Such scores are used to focus on more responsive members over less responsive ones. However, the conventional systems are devoid of providing the service provider with a view at opportunity level, and relative importance of the opportunity. Further, the conventional management systems do not consider personas associated with the identified members in order to elevate the priority of a particular member's interaction. Finally, the systems do not consider signals regarding an elevated interest in the services provided by the organization currently. If an account has a current “surge” of interest in the services they are more likely to be looking to purchase a solution in the present and so the opportunity priority should be increased. Therefore, there is a need for a system and method for prioritization of effective accounts that can efficiently determine priority of the account based on all the related buying committee members of a particular account and one or more personas associated with such buying committee members along with any intent signal surges so as to make the demand generation process more efficient.

There is plurality of lead management systems that typically determine score of leads, where such lead core indicates worthiness of leads, or potential consumers, by attributing values to such worthiness based on behavior of consumers relating to interest in products or services. Such lead generation systems do not consider influence of related other lead of a particular entity or organization. In an example scenario, an organization providing service and/or product identifies a consumer organization for selling service and/or product of the provider organization. The existing lead management system determines relevant leads in the consumer organization and assign a lead score based on the responses of those leads. Such lead scores are used to focus on more responsive leads over less responsive ones. However, the conventional lead management systems are devoid of providing the service provider with a view of all the leads in that account, and relative importance of the leads. Further, the conventional lead management systems do not consider personas associated with the generated leads in order to determine priority of the lead.

Therefore, there is a need for a system and method for prediction of effective accounts that can efficiently determine priority of the account based on the all the related leads of a particular consumer organization and one or more personas associated with such leads so as to make the demand generation process more accurate.

### SUMMARY

One or more shortcomings of the prior art are overcome, and additional advantages are provided through the present disclosure. Additional features and advantages are realized through the techniques of the present disclosure. Other embodiments and aspects of the disclosure are described in detail herein and are considered a part of the claimed disclosure.

Accordingly, the present disclosure relates to a method for prioritizing business opportunities. The method includes periodically analyzing activities performed by a group of buying committee members, determining a score for each of the group of buying committee members based on the analysis. The method comprises computing a persona score based on the determined scores of the buying committee members, determining a base opportunity score based on weighted average of the computed persona score. The method further comprises determining a surge score by analyzing intent signals from accounts, and determining an opportunity score based on the base opportunity score and the surge score.

Further, the disclosure relates to a system for prioritizing business opportunities. The system comprises a processor, and one or more user devices coupled with the processor. The system further comprises a memory communicatively coupled with the processor, wherein the memory stores processor-executable instructions, which, on execution, cause the processor to periodically analyze activities performed by a group of buying committee members. The processor is configured to determine a score for each of the group of buying committee members based on the analysis and compute a persona score based on the determined scores of the buying committee members. The processor further determines a base opportunity score based on weighted average of the computed persona score, and determines a surge score by analyzing intent signals from accounts. The processor further determines an opportunity score based on the base opportunity score and the surge score.

Furthermore, the present disclosure relates to a non-transitory computer readable medium including instructions stored thereon that when processed by at least one processor cause a system to periodically analyze activities performed by a group of buying committee members. Further, the instructions cause the processor to determine a score for each of the group of buying committee members based on the analysis and compute a persona score based on the determined scores of the buying committee members. Furthermore, the instructions cause the processor to determine a base opportunity score based on weighted average of the computed persona score, and determine a surge score by analyzing intent signals from accounts. Further, the instructions cause the processor to determine an opportunity score based on the base opportunity score and the surge score.

The foregoing summary is illustrative only and is not intended to be in anyway limiting. In addition to the illustrative aspects, embodiments, and features described above, further aspects, embodiments, and features will become apparent by reference to the drawings and the following detailed description.

### BRIEF DESCRIPTION OF DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1 illustrates an exemplary architecture of a system for opportunity scoring and prioritization, in accordance with some embodiments of the present disclosure;

FIG. 2 illustrates a block diagram of the opportunity scoring and prioritization system of FIG. 1 in accordance with some embodiments of the present disclosure;

FIG. 3 illustrates a flowchart showing a method of the opportunity scoring and prioritization system in accordance with some embodiments of present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternative falling within the scope of the disclosure.

The terms “comprises”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and system of prioritizing business opportunities. The method enables prioritization of effective business opportunities by determining score of opportunities based on all the marketing interactions with buying committee members of a particular account and one or more personas associated with such accounts so as to prioritize business opportunities. The method comprises identifying a set of buying committee members from one or more organizations, wherein their activities indicate email, web, and social media interactions of the buying committee members to one or more outbound messages shared by services and/or product providing organizations. Such interactions are received in terms of a plurality of activities such as opening a mail containing marketing content, visiting a webpage of service and/or product providing organization, downloading an asset, replying to outbound messages etc. The method further comprises the step of periodically analyzing the net new activities performed by buying committee members in the current time interval and identifying the right activity type associated with each of those activities. The method then determines a score for each of the activities and responses by using a custom scoring model, and validating the activities and responses in order to determine they are valid and not generated by “bot” programs. Invalid “bot” generated activities and responses are filtered out from scoring. For example, a plurality of Bot generated web visit, opens, clicks, replies are excluded. The method also incorporates intent signals from the organizations that point to a current interest in the service and/or products of the providing organization. The method comprises determining a score for each of the activities and responses by using a custom scoring model and computing a score by aggregating the scores of each of the filtered activities upon determination of scores for each of the filtered activities. The method includes classifying the buying committee member information into a persona, wherein the persona indicates a group of similar buying committee members from specific department(s) and level(s) as defined by the marketer. The method further comprises aggregating a weighted average persona score based on activities performed by buying committee members belonging to that specific persona. The method further comprises steps of computing a base opportunity score based on these prioritized persona scores. The method finally computes an overall opportunity score by adding the component of intent “surge” for the account.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

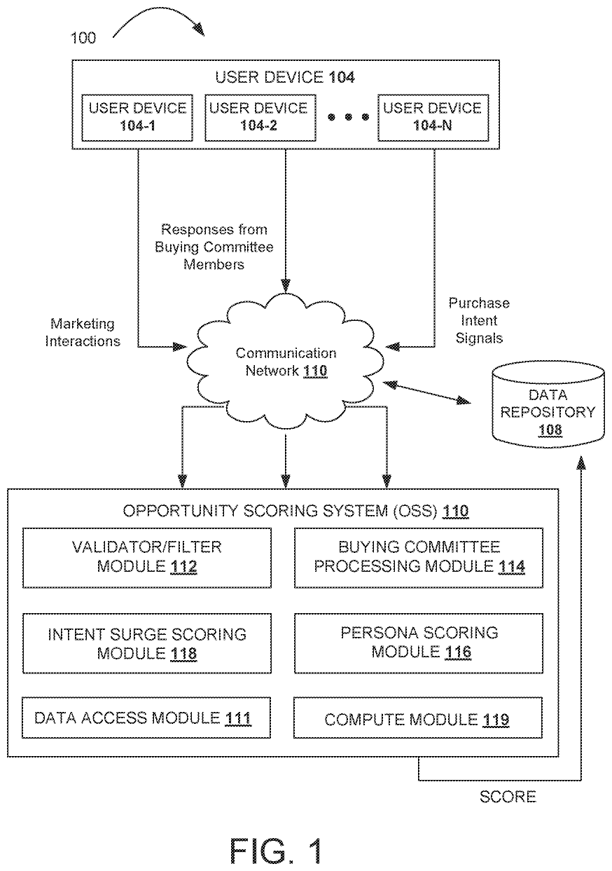

FIG. 1 illustrates an exemplary architecture of a system for opportunity scoring and prioritization, in accordance with some embodiments of the present disclosure. As shown in FIG. 1, the exemplary system (100) comprises one or more components configured for prioritizing business opportunities with enhanced efficacy and accuracy. The exemplary system (100) discloses an opportunity scoring system (102) (hereinafter referred to as OSS), one or more external user devices (104-1, 104-2 . . . 104-N) (hereinafter referred to as user device (104)), and a data repository (108) communicatively coupled via a communication network (110). The communication network (110) may include, without limitation, a direct interconnection, local area network (LAN), wide area network (WAN), wireless network (e.g., using Wireless Application Protocol), the Internet, etc.

The user device (104) is an electronic equipment designed to serve particular purpose according to the requirement of the end user. The user device (104) may be a mobile device generally a portable computer or a computing device including the functionality for communicating over the communication network (110). For example, the mobile device can be a conventional web-enabled personal computer in the home, mobile computer (laptop, notebook, or subnotebook), Smart Phone (iPhone, Android), tablet computer or another device capable of communicating over the Internet or other appropriate communications network. In one embodiment, the user can be an authorized marketer of an organization who provides services and/or products for fulfilling requirements of one or more accounts. The marketer can perform a plurality of activities related to buying committee member generation. Such activities include but are not limited to content marketing, social media marketing, search engine optimization, advertising products and/or service, etc. In another embodiment, the user can be a marketing expert who can deal with different mode of marketing channels and buying committee member communication such as email marketing, sharing events, publishing digital content, sharing blogs etc. In one embodiment, the user device (104) is configured to transmit a plurality of data such as buying committee member information, marketing information, etc. related to the accounts to the OSS (102) for effectively determining priority buying committee members.

In one embodiment, the users from an account can be authorized buying committee members from different hierarchies of the account, wherein different users are assigned for managing different requirements of services and/or products for fulfilling requirements of the account. In an example, a CTO (Chief Technology Officer) of an organization may respond to marketing content for a specific requirement, whereas a junior engineer may respond to some other related marketing content for other requirements. The users can perform a plurality of activities related to responding to a marketing content shared by one or more service and/or product providing organizations. Such activities include but are not limited to opening a mail containing marketing content, visiting a webpage of service and/or product providing organization, downloading an asset, replying to advertisement messages etc. In one embodiment, the user device (104) is configured to transmit a plurality of data such as information of account, response information, etc. to the OSS (102) for effectively prioritizing buying committee members. In one embodiment, the user device (104) also comprises a user application (not depicted in the figures) to receive user data from the users of the accounts. The respective user application of the user device is further configured to display details of different services and/or products, communication from service and/or product providing organizations etc.

The data repository (108) stores plurality of information related to plurality of accounts, requirements of the accounts, details of products and services of supplier organizations, marketing content, etc. In one embodiment, the data repository (108) is configured to store buying committee members information, responses of accounts, buying committee member quality information, information of personas of the accounts, feedback information of buying committee members executed through the OSS (102), a plurality of evaluation criteria for effective opportunity prioritization etc. In one embodiment, the data repository (108) is configured to store one or more information received as input from the marketer of the organization via user application from a user device (104). As an example, the input data from the marketer includes but not limited to marketable products and/or services, marketing channel, target accounts, etc. In one embodiment, the data repository (108) is also configured to store one or more information received as input from the user of the account via respective user application from a user device (104). As an example, the input data from the user of an account includes but not limited to response to the marketing content, behavioral pattern for responding to marketing content, one or more queries for the organizations providing services and/or products etc. In one embodiment, the data repository (108) may be configured as a standalone device independent from the OSS (102). In another embodiment, the data repository (108) may be integrated with the OSS (102).

The OSS (102) comprises at least a data access module (111), a buying committee member processing module (114), an intent surge scoring module (118), and a compute module (119). The data access module (111) is configured to accumulate information of products and/or services, marketing content, information of marketing channels, account information, information of one or more personas of accounts, historical buying committee member information etc. The buying committee member processing module (114) is configured to periodically analyze activities performed by one or more users of an account. The intent surge scoring module (118) is configured to detect an increase in interest demonstrated by the account in the services and/or products of the organization. The compute module (119) is configured to determine scores for the accounts based on the buying committee members scores and the intent scores. The compute module (119) is further configured to determine a persona score based on persona associated with each of the buying committee members and to determine the opportunity score as a weighted average of the persona score along with a contribution from the intent surge score.

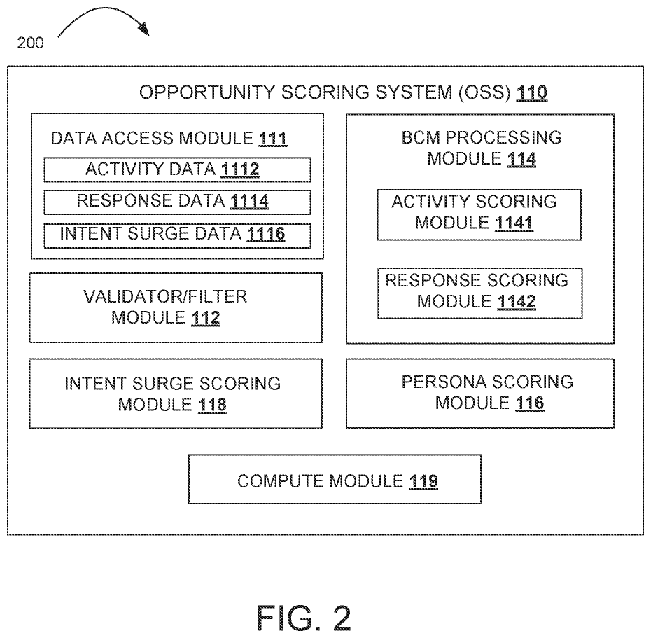

In an embodiment, the OSS (102) may be a typical OSS as illustrated in FIG. 2. The OSS (102) comprises the data access module (111), the validation/filtering module (112), the buying committee member processing module (114), the persona scoring module (116), the intent surge scoring module (118), and the compute module (119). In one implementation, the data may be stored within the memory in the form of various data structures. Additionally, the data may be organized using data models, such as relational or hierarchical or unstructured data models. In one example, the data may include activity data (1112), response data (1114), and intent surge data (1116). In one example, the account data defines a plurality of information of one or more users of plurality of accounts. The plurality of information includes but is not limited to user details including designation, roles and responsibilities, organizational requirements etc. Other data may include temporary data and temporary files, generated by the modules for performing the various functions of the OSS (102).

The OSS modules may also comprise other modules to perform various miscellaneous functionalities of the OSS (102). It will be appreciated that such aforementioned modules may be represented as a single module or a combination of different modules. The modules may be implemented in the form of software executed by a processor, hardware and/or firmware.

In one embodiment, the data access module (111) receives input of one or more marketers of organizations providing services and/or products. The marketers select marketing content, one or more marketing channels to broadcast the marketing content, one or more target accounts etc. as per the marketing requirement of the organization. The data access module (111) further receives input of one or more users of the one or more target accounts. Each of the user receives the broadcasted marketing content in respective marketing channel communication and responds to such communication by using one of a plurality of activities. The plurality of activities includes but not limited to opening a mail containing marketing content, visiting a webpage of service and/or product providing organization, downloading an asset, replying to advertisement messages etc. The user also performs actions unrelated to the marketing content provided but that still signals an intent to purchase the services and/or products of the organization. These actions could be searching the internet, viewing competitors' websites, posting forum questions and so son. The data repository (108) stores all this information as activity data (1112), response data (1114), and intent surge data (1116).

The data repository (108) stores the activity information from the activities performed by respective users of one or more accounts that is classified as observed activities (1112) or interactive activities (1114).

In one embodiment, the validator/filter module (112) further analyzes the observed activities in order to determine validity of the activities. In recent days, the internet is populated by “bots” i.e., automated systems that also perform activities such as opening and checking emails, visiting websites, etc. Therefore, consideration of bot activities as valid buying committee member activities leads to inaccurate determination of the members for business. Thus, before the analysis of the activities by the (BCM) buying committee members processing module (114), this module filters out the activities performed by bots and other automated systems. Further, the validator/filter module (112) is also configured to filter out a plurality of other activities such as visiting a page multiple times by a buying committee member, or opening the same email again etc. The validator/filter modules (112) is configured with heuristics computation techniques to recognize a pattern of speed and repetitiveness in bot activities and filter such bot activities out. The validator/filter modules (112) can also be configured with optimized filtering techniques in order to provide better performance during execution of such filtering processes.

In an example, filtering each activity against the entire history of the activity table is a very inefficient method of performing a filter. In technical terms, this gives a process performance as O(n^{log}^{₂} ^{(m)}), where n is new activities, and m is all the activities in the table. Thus, a single request is made for a set of activities in the last week and is traversed the same, filtering out all except the first (valid) record. Such technique improves the performance somewhat to become an O(nm′), m′ is the week's activities. Further, the key elements of the rule are hashed and the results are stored in a set. When a hash collision is found, the respective activity is filtered out and thereby provides an excellent performance of O(n+m′). Therefore, the filtering optimization increases the complexity of the underlying techniques but gives a good performance bump.

The BCM (buying committee member) processing module (114) retrieves filtered observed activity data (1112), and interactive (response) activity data (1114) for processing by the activity scoring module (1141) and the response scoring module (1142). In an example, the observed activities include but not limited to opening an email, visiting a website, downloading a whitepaper etc. The interactive activities include but not limited to sending a response to an email etc.

The activity scoring module (1141) further determines a score for each of the observed activities by using a first predefined mapping data. In an example, the first predefined mapping data can be illustrated as described in Table 1.

TABLE 1

| Buying Committee Member Activity | Score |
|---|---|
| Email Open | x |
| Asset Download | y |
| Web Visit | z |

The response scoring module (1142) further determines a score for each of the interactive activities by using a second predefined mapping data. In an example, the second predefined mapping data can be illustrated as described in Table 2.

TABLE 2

| Type of Response | Score |
|---|---|
| Requesting Content | a |
| Requesting Demo | b |
| Requesting More Information | c |
| Neutral Reply | d |
| Negative Reply | e (<0) |

Upon determination of scores for each of the filtered activities, the BCM processing module (114) computes a buying committee member score by aggregating the scores of each of the filtered activities. In an example, the buying committee member score

$${L}_{score} = {\sum }_{activity} {a}_{score} , where {a}_{score} is the activity score . \qquad Equation 1$$

The persona scoring module (116) next classifies the buying committee member information into a persona, wherein the persona indicates a designated role in the account who administers one or more requirements of the account. The persona scoring module (116) further determines a persona score using the score of all buying committee members for which the aggregated score is more than a predefined threshold value. In an example, a persona can be represented as an amalgamation of buying committee members that means the persona represents all buying committee members that perform a given role in the account. Further, the persona score is the average of all engaged buying committee members in that persona. The engaged buying committee members indicate one or more buying committee members with actual member's interest among a plurality of buying committee members.

In an example, a Persona is considered to be an amalgamation of the buying committee member scores. The persona score is the average of all engaged buying committee members in that persona. Therefore, persona score is defined as,

$$Equation 2$$

$${P}_{score} = {\sum }_{members} \frac{{L}_{score}}{{n}_{e}} , wherein {n}_{e} is the number of engaged buying \\ committee member , ( {L}_{score} > {Δ}_{e} ) .$$

Δₑ is the threshold value. The number of engaged buying committee members are considered to perform most trivial activities for showing actual interest. Thus, the Δe i.e., threshold value is determined efficiently so as to filter out the members who are not actually interested.

Upon determining the persona score, the compute module (119) assigns a priority for each of the engaged personas, wherein the engaged personas indicate one or more personas who are actively administering the one or more requirements of the organizations by responding to the marketing content shared by the providers. In an example, a Chief Executive Officer (CEO) of an organization is assigned with higher priority with respect to a mid-level manager of the organization. The compute module (119) further computes a base opportunity score based on the weighted average persona scores. In one embodiment, the compute module (119) can also be configured with optimized scoring technique in order to provide better performance during execution of such scoring process. In one embodiment, the compute module (119) can also be configured with optimized scoring technique in order to provide better performance during execution of such scoring process.

In an example, scores of buying committee members are tracked with respect to priority of personas and the base opportunity score is determined as:

$${Op}_{score} = \frac{\sum {P}_{score} \cdot {P}_{pri}}{\sum {P}_{pri}} , {P}_{pri} is the priority of persona . \qquad Equation 3$$

Additionally, the optimized base opportunity score is determined by:

$${Op}_{score} = {Op}_{oldscore} \frac{{P}_{Δ pri}}{\sum {P}_{pri}} . {Op}_{Δ score} \qquad Equation 4$$

In one embodiment, the intent surge scoring module (118) is configured to enhance the base opportunity score using surge signals. In an example, there can be a recent “surge” in interest in one or more services/products associated with the opportunity, then the respective opportunity score is recalculated by giving a higher score. The compute module (119) is configured to aggregate an opportunity score from the base opportunity score and the intent surge score calculated before. The opportunity score is then assigned to an account which can be used to prioritize highly scored account Opportunities.

In an example, an intent score is determined for the past three weeks vs the past twelve weeks and a small surge delta (Δ_{surge}) is added to the score of the Opportunity based on the change. To calculate the surge delta (Δ_{surge}), the percent change between the average score of the past three weeks vs the past twelve weeks is determined:

$${C}_{intent} = \frac{{AvgScore}_{3 w}}{{AvgScore}_{12 w}} \times 100 \qquad Equation 5$$

Further, a weighted intent score is computed based on the Cᵢₙₜₑₙₜ as illustrated below.

$${w}_{intent} = \{ \begin{matrix}{C}_{intent} = 0 , & then 0 \\ {C}_{intent} < 25 \% , & then \text{?} 22 \\ {C}_{intent} < 45 \% , & then \text{?} 30 \\ {C}_{intent} < 65 \% , & then \text{?} 35 \\ {C}_{intent} < 80 \% , & then \text{?} 45 \\ {C}_{intent} < 100 \% , & then \text{?} 55 \\ {C}_{intent} < 200 \% , & then \text{?} 70 \\ {C}_{intent} < 300 \% , & then \text{?} 80 \\ {C}_{intent} < 400 \% , & then \text{?} 85 \\ {C}_{intent} \geq 400 \% , & then \text{?} 88\end{matrix}$$

$$\text{?} \text{indicates text missing or illegible when filed}$$

Finally, the surge delta is determined as:

$${Δ}_{surge} = {w}_{i ntent} - {w}_{oldintent} \qquad Equation 6$$

Further, the primary function of the compute module (119) is to highlight which opportunities to focus on to obtain effective business deals. If the scores remain static then any deviation in interests of the members as time progresses may lead to creating trouble for the providers to manage the business deals who should be focusing on more recent interested parties. In order to avoid such a problem, the compute module (119) considers a decay factor while computing buying committee member scores, persona scores, and opportunity scores.

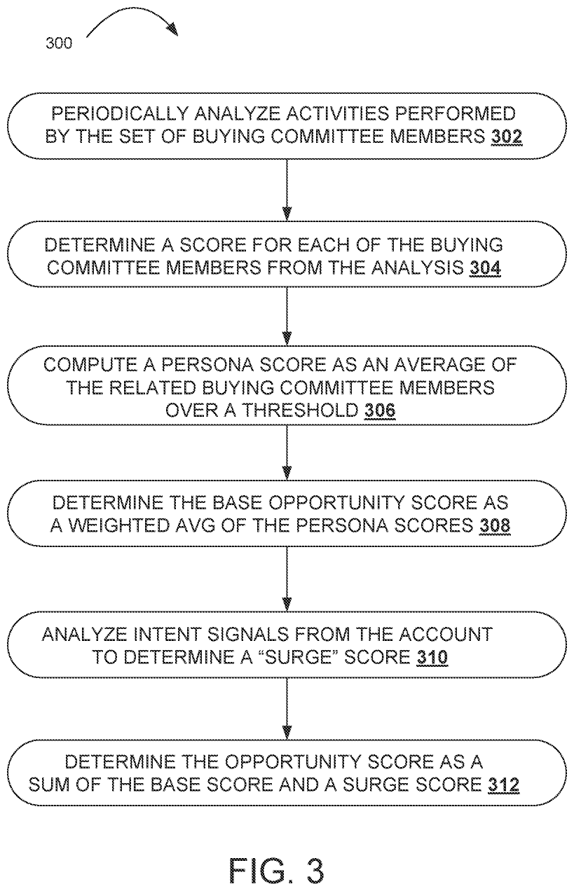

FIG. 3 illustrates a flowchart showing a method of opportunity scoring and prioritization system in accordance with some embodiments of present disclosure. As illustrated in FIG. 3, the method (300) comprises one or more blocks implemented by the OSS (110) for scoring and prioritizing business opportunities. The method (300) may be described in the general context of computer executable instructions. Generally, computer executable instructions can include routines, programs, objects, components, data structures, procedures, modules, and functions, which perform specific functions or implement specific abstract data types.

The order in which the method (300) is described is not intended to be construed as a limitation, and any number of the described method blocks can be combined in any order to implement the method. Additionally, individual blocks may be added and deleted from the methods without departing from the spirit and scope of the subject matter described herein. Furthermore, the method can be implemented in any suitable hardware, software, firmware, or combination thereof.

At block (302), activities performed by the set of buying committee members are periodically analyzed. In an embodiment, the BCM (buying committee member) processing module (114) retrieves the observed activity information (1112) and interactive activity information (1114) as stored in the data repository (108) and uses the activity scoring module (1141) and the response scoring module (1142) to calculate a score. In an example, the observed activities include but not limited to opening an email, visiting a website, downloading a whitepaper etc. The interactive activities include but not limited to sending a response to an email etc. The BCM (buying committee member) processing module (114) further determines a score for each of the observed activities by using the first predefined mapping data and a score for each of the interactive activities by using the second predefined mapping data.

At block (304), a score is determined for each of the set of buying committee members based on the analysis. In one embodiment, upon determination of scores for each of the filtered activities, the BCM processing module (114) computes a buying committee member score by aggregating the scores of each of the activities.

At block (306), a persona score is computed based on the determined buying committee member score. In an embodiment, the persona scoring module (116) classifies the buying committee member information into a persona, wherein the persona indicates a designated role of the account who administers one or more requirements of the account. The Persona scoring module (116) further determines a persona score for the buying committee member information for which the aggregated score is more than a predefined threshold value.

At block (308), a base opportunity score is determined based on the weighted average of the computed persona score. In one embodiment, upon determining the persona score, the compute module (119) assigns a priority or weight for each of the engaged personas, wherein the engaged personas indicate one or more personas who are actively administering the one or more requirement of the organizations. The compute module (119) further computes a base opportunity score based on the weighted persona scores. In one embodiment, the compute module (119) can also be configured with optimized scoring technique in order to provide better performance during execution of such scoring process.

At block (310), the intent surge scoring module (118) analyzes signals from the account that highlight their current interest in the services and/or products of the marketing organization. In an example, the users of the account could visit competitors' pages, make internet searches related to the services and/or products of the organization, or post questions in a relevant forum etc. The intent surge scoring module (118) will look for signals of a recent surge in interest from the account and use it to determine a “surge” score for each account.

At block (312), the opportunity scoring system (110) uses the compute module (119) to aggregate an opportunity score from the base opportunity score and the intent surge score calculated before. This score is then assigned to an account which can be used to prioritize highly scored account Opportunities.

The present invention provides a technical effect by providing a technical solution to the problem of account management as faced by a plurality of organizations due to lack of computational efficiency and sustainable solutions etc. The present invention provides a unique technique that can prioritize a more accurate opportunity score in addition to the buying committee member score, wherein computation of such opportunity scores takes influencing factor of one or more personas for a account in consideration in order to effectively forecast probability of business opportunity that can be converted into business with more assurance. The present invention also enables the service and/or product providing organizations to receive such opportunity score for easy interpretation in real time, wherein such opportunity scores are determined in an optimized technique without incurring redundant processing time.

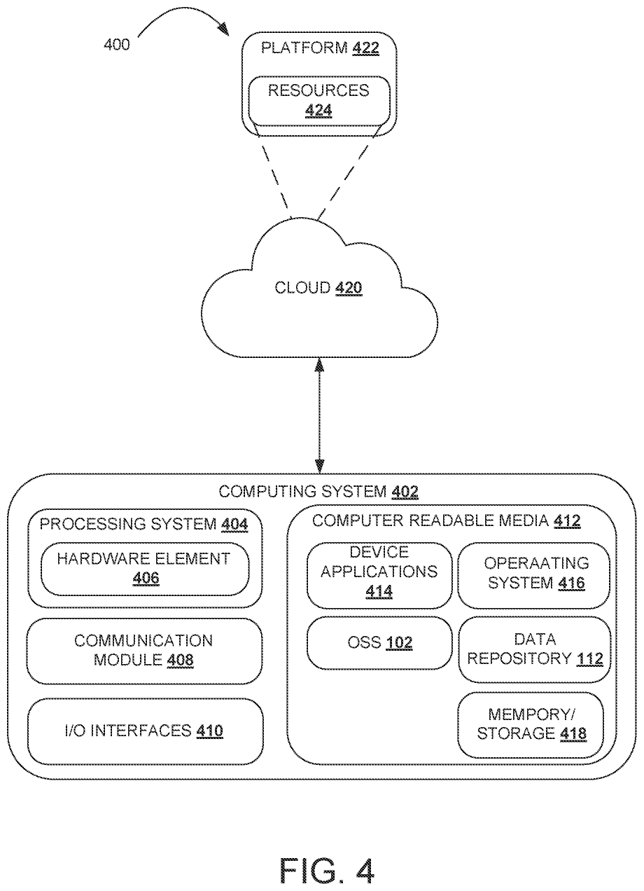

FIG. 4 is a block diagram of an exemplary computer system for implementing embodiments consistent with the present disclosure.

The operating environment (400) illustrates various components of an example computing system (402) that can be implemented for predicting accurate business lead from one or more consumer organization.

The computing system (402) includes a processing system (404) (e.g., any of microprocessors, controllers, or other controllers) that can process various computer-executable instructions to control the operation of the computing system (402) and to enable techniques for, or in which can be implemented, procurement management. Alternatively or additionally, the computing system (402) can be implemented with any one or combination of hardware elements (406), firmware, or fixed logic circuitry that is implemented in connection with processing and control circuits. Although not shown, the computing system (402) can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The computing system (402) also includes a communication module (408) that enables wired and/or wireless communication of data (e.g., external data). The communication module (408) can be implemented as one or more of a serial and/or parallel interface, a wireless interface, any type of network interface, a modem, or as any other type of communication interface. The communication module (408) provides a connection and/or communication links between the computing system (402) and a communication network by which other electronic, computing, and communication devices communicate data with the computing system (402).

The computing system (402) includes I/O interfaces (410) for receiving and providing data. For example, the I/O interfaces (410) may include one or more of a touch-sensitive input, a capacitive button, a microphone, a keyboard, a mouse, an accelerometer, a display, an LED indicator, a speaker, or a haptic feedback device.

The computing system (402) also includes computer-readable media (412), such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewritable compact disc (CD), any type of a digital versatile disc (DVD).

The computer-readable media (412) provides data storage mechanisms to store various device applications (414), an operating system (416), and memory/storage (418) and any other types of information and/or data related to operational aspects of the computing system (402). For example, an operating system (416) can be maintained as a computer application within the computer-readable media (412) and executed on the processing system (404). The device applications (414) may include a device manager, such as any form of a control application, software application, or signal-processing and control modules. The device applications (414) may also include system components, engines, or managers to implement real time prediction of accurate business lead, such as the LPS (102), the data repository (108) or the user application (130). The computing system (402) may also include, or have access to, one or more machine learning systems.

Using the communication module (408), the computing system (402) may communicate via a cloud computing service (cloud) (420) to access a platform (422) having resources (424). In some implementations, the LPS (102), the data repository (108), are located at the resources (424) and are accessed by the computing system (402) via the cloud (420).

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

While various aspects and embodiments have been disclosed herein, other aspects and embodiment will be apparent to those skilled in the art.

1. A method (300) for prioritizing business opportunities, the method comprises steps of:
periodically analyzing (302) activities performed by a group of buying committee members;
determining (304) a score for each of the group of buying committee members based on the analysis;
computing (306) a persona score based on the determined scores of the buying committee members;
determining (308) a base opportunity score based on weighted average of the computed persona score;
determining (310) a surge score by analyzing intent signals from accounts; and
determining (312) an opportunity score based on the base opportunity score and the surge score.

2. The method (300) as claimed in claim 1, wherein the periodical analysis of activities comprises the steps of:
retrieving activity information including observed activity information and interactive activity information from user devices of one or more buying committee members;
analyzing each of the retrieved activity information to identify activities performed by automated systems and activities having multiple occurrences; and
determining a set of key activities including observed activity information and interactive activity information upon filtering out the activities performed by automated systems and activities having multiple occurrences as identified.

3. The method (300) as claimed in claim 2, wherein the activities performed by the automated systems are identified by monitoring pattern of interactions made by the buying committee members in respective user devices in terms of speed of interactions and recognizing the interactions being performed by automated systems.

4. The method (300) as claimed in claim 2, wherein the process of filtering out the identified activities either performed by automated systems or having multiple occurrences is optimally performed by considering only newly determined key activities with respect to activities previously processed for filtering in order to reduce processing time.

5. The method (300) as claimed in claim 1, the score for each of the buying committee members is determined by:
computing a first score for each of the observed activity information of the set of key activities by using a first pre-defined mapping;
computing a second score for each of the interactive activity information of the set of key activities by using a second pre-defined mapping; and
computing the score for each of the buying committee members by aggregating the first scores and the second scores of filtered activities as performed by the respective buying committee member.

6. The method (300) as claimed in claim 1, wherein the persona score is computed by using the scores of all buying committee members for which the aggregated score is more than a predefined threshold value, wherein the persona represents all buying committee members that perform a given role in an account.

7. The method (300) as claimed in claim 1, wherein the surge score is determined based on an indication of surge in interest from an account, wherein the surge score is computed upon determining change in base opportunity score during a specified time interval.

8. The method (300) as claimed in claim 1, wherein the scores of buying committee members, the persona scores, and the opportunity scores are further computed with respect to a decay factor, wherein the decay factor reduces the scores over the time based on inactive or old leads, opportunities and personas.

9. A system for prioritizing business opportunities, the system comprising:
a processor and one or more user devices coupled with the processor;
a memory communicatively coupled with the processor, wherein the memory stores processor-executable instructions, which on execution, cause the processor to:
periodically analyze activities performed by a group of buying committee members;
determine a score for each of the group of buying committee members based on the analysis;
compute a persona score based on the determined scores of the buying committee members;
determine a base opportunity score based on weighted average of the computed persona score;
determine a surge score by analyzing intent signals from accounts; and
determine an opportunity score based on the base opportunity score and the surge score.

10. The system as claimed in claim 9, wherein the processor is configured to periodically analyze the activities by:
retrieving activity information including observed activity information and interactive activity information from user devices of one or more buying committee members;
analyzing each of the retrieved activity information to identify activities performed by automated systems and activities having multiple occurrences; and
determining a set of key activities including observed activity information and interactive activity information upon filtering out the activities performed by automated systems and activities having multiple occurrences as identified.

11. The system as claimed in claim 10, wherein the processor is configured to identify the activities performed by the automated systems by monitoring pattern of interactions made by the buying committee members in respective user devices in terms of speed of interactions and recognizing the interactions being performed by automated systems.

12. The system as claimed in claim 10, wherein the processor is configured to optimally perform the process of filtering out the identified activities either performed by automated systems or having multiple occurrences by considering only newly determined key activities with respect to activities previously processed for filtering in order to reduce processing time.

13. The system as claimed in claim 9, the processor determines score for each of the buying committee members by:
computing a first score for each of the observed activity information of the set of key activities by using a first pre-defined mapping;
computing a second score for each of the interactive activity information of the set of key activities by using a second pre-defined mapping; and
computing the score for each of the buying committee members by aggregating the first scores and the second scores of filtered activities as performed by the respective buying committee member.

14. The system as claimed in claim 9, wherein the processor computes the persona score by using the scores of all buying committee members for which the aggregated score is more than a predefined threshold value, wherein the persona represents all buying committee members that perform a given role in an account.

15. The system as claimed in claim 9, wherein the processor determines the surge score based on an indication of surge in interest from an account, wherein the surge score is computed upon determining change in base opportunity score during a specified time interval.

16. The system as claimed in claim 9, wherein the processor further computes the scores of buying committee members, the persona scores, and the opportunity scores with respect to a decay factor, wherein the decay factor reduces the scores over the time based on inactive or old leads, opportunities and personas.

17. A non-transitory computer-readable storage medium that stores instructions executable by a processor that, in response to execution of the instructions, cause the processor to perform operations comprising:
periodically analyzing activities performed by a group of buying committee members;
determining a score for each of the group of buying committee members based on the analysis;
computing a persona score based on the determined scores of the buying committee members;
determining a base opportunity score based on weighted average of the computed persona score;
determining a surge score by analyzing intent signals from accounts; and
determining an opportunity score based on the base opportunity score and the surge score.

18. The non-transitory computer-readable storage medium as claimed in claim 17, wherein the operations further cause the processor to periodically analyze the activities by:
retrieving activity information including observed activity information and interactive activity information from user devices of one or more buying committee members;
analyzing each of the retrieved activity information to identify activities performed by automated systems and activities having multiple occurrences; and
determining a set of key activities including observed activity information and interactive activity information upon filtering out the activities performed by automated systems and activities having multiple occurrences as identified.

19. The non-transitory computer-readable storage medium as claimed in claim 18, wherein the operations cause the processor to identify the activities performed by the automated systems by monitoring pattern of interactions made by the buying committee members in respective user devices in terms of speed of interactions and recognizing the interactions being performed by automated systems.

20. The non-transitory computer-readable storage medium as claimed in claim 18, wherein the operations cause the processor to optimally perform the process of filtering out the identified activities either performed by automated systems or having multiple occurrences by considering only newly determined key activities with respect to activities previously processed for filtering in order to reduce processing time.

21. The non-transitory computer-readable storage medium as claimed in claim 17, the operations further cause the processor to determine score for each of the buying committee members by:
computing a first score for each of the observed activity information of the set of key activities by using a first pre-defined mapping;
computing a second score for each of the interactive activity information of the set of key activities by using a second pre-defined mapping; and
computing the score for each of the buying committee members by aggregating the first scores and the second scores of filtered activities as performed by the respective buying committee member.

22. The non-transitory computer-readable storage medium as claimed in claim 17, wherein the operations cause the processor to compute the persona score by using the scores of all buying committee members for which the aggregated score is more than a predefined threshold value, wherein the persona represents all buying committee members that perform a given role in an account.

23. The non-transitory computer-readable storage medium as claimed in claim 17, wherein the operations cause the processor to determine the surge score based on an indication of surge in interest from an account, wherein the surge score is computed upon determining change in base opportunity score during a specified time interval.

24. The non-transitory computer-readable storage medium as claimed in claim 17, wherein the operations further cause the processor to compute the scores of buying committee members, the persona scores, and the opportunity scores with respect to a decay factor, wherein the decay factor reduces the scores over the time based on inactive or old leads, opportunities and personas.
